(19) United States
(12) Patent Application Publication
(10) Pub. No.: US 2010/0309829 A1
(43) Pub. Date: Dec. 9, 2010

(54) TIME-REVERSAL PRE-EQUALIZATION METHOD

(75) Inventors: Dinh Thuy Phan Huy, Paris (FR); Jean-Marie Chaufray, Chantenay Malabry (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: FRANCE TELECOM, PARIS (FR)

(21) Appl. No.: 12/745,085

(22) PCT Filed: Dec. 19, 2008
(86) PCT No.: PCT/FR08/52378

§ 371 Date: Jul. 9, 2010

(30) Foreign Application Priority Data
Dec. 21, 2007 (FR) 07 60225

(51) Int. Cl. H04J 1/00

(52) U.S. Cl. 370/281

(57) ABSTRACT

A method of pre-equalizing a data signal transmitted by a source communicating entity comprising a set of source antennas to a destination communicating entity comprising a set of destination antennas, the method comprising a step of a reference antenna of the set of source antennas receiving a first pulse transmitted by a destination antenna via a first propagation channel, a step of the reference antenna receiving a combined impulse response representing the successive passages of a second pulse through a second propagation channel between a source antenna and the destination antenna and the first propagation channel, a step of time reversing the combined impulse response, a step of combining the time-reversed combined impulse response and an impulse response representing the passage of said first pulse through said first propagation channel, the above steps being repeated for at least a portion of the set of destination antennas and at least a portion of the set of source antennas, and a step of determining pre-equalization coefficients of the data signal from a set of the combinations of impulse responses.

The present invention relates to a method of pre-equalizing a data signal, for example one transmitted in a frequency-division duplex (FDD) radio communications network.

In an FDD network two communicating entities transmit data signals in different frequency bands. The communicating entities are radio terminals, terrestrial or satellite base stations or radio access points, for example. The invention relates to single-input, single-output (SISO) radio communications networks, in which the communicating entities have a single antenna, multiple-input, multiple-output (MIMO) networks, in which the communicating entities have a plurality of antennas, and single-input, multiple-output (SIMO) or multiple-input, single-output (MISO) networks combining communicating entities having one antenna and communicating entities have a plurality of antennas.

A radio signal (antenna signal) transmitted by an antenna of a communicating entity suffers distortion as a function of the propagation conditions between a source point defined at the output of the source antenna and a destination point defined at the input of an antenna of the destination communicating entity. To limit such distortion, the antenna signal is pre-distorted by applying pre-equalization coefficients as a function of the characteristics of the propagation channel between the two antennas. It is therefore necessary to characterize this propagation channel.

Of existing pre-equalization methods, time-reversal methods are distinguished by their reduced complexity and by their performance.

Time reversal is a technique for focusing waves, typically acoustic waves, that relies on the invariance of the time-reversed wave equation. Thus a time-reversed wave propagates like a direct wave traveling backward in time.

A brief pulse transmitted from a source point propagates in a propagation medium. Part of this wave received by a destination point is time reversed before being sent back in the same propagation medium. The wave converges towards the source point, where it forms a brief pulse. The signal collected at the source point is of virtually identical shape to the source signal transmitted from the source point. In particular, the more complex the propagation medium, the more accurately the time-reversed wave converges. Time reversing the propagation channel to which the wave is applied makes it possible to cancel out the effect of said channel on the wave pre-distorted in this way transmitted from the source point.

Thus the time reversal technique is used in radio communications networks to cancel out the effect of the propagation channel on the antenna signal, notably by reducing channel spreading, and to simplify the processing of symbols received after passing through the channel. The antenna signal transmitted by an antenna of the source communicating entity is pre-equalized by applying coefficients obtained from the time-revered impulse response of the propagation channel through which this antenna signal must pass. Applying time reversal thus requires a knowledge by the source communicating entity of the propagation channel in the frequency band dedicated to communications issuing from that entity.

FDD transmission from a source communicating entity to a destination communicating entity and transmission in the opposite direction are effected in different frequency bands. For example, for a radio communications system this means uplink transmission in a first frequency band from a mobile radio terminal to a base station and downlink transmission in a second frequency band from a base station to a mobile radio terminal. Although a communicating entity can estimate a propagation channel on the basis of receiving a signal passing through the channel, it cannot estimate a propagation channel on the basis of a signal transmitted in a different frequency band. It is therefore particularly beneficial for this type of transmission to use a technique for pre-equalizing antenna signals.

A first solution is proposed in the paper entitled “From theory to practice: an overview of MIMO space-time coded wireless systems” by David Gesbert, Mansoor Shafi, Da-Shan Shiu, Peter J Smith, and Aymon Naguib, published in IEEE Journal on Selected Areas in Communication, vol. 21, no. 3, April 2003. The proposed method uses time reversal as a pre-equalization technique with coefficients evaluated on the basis of the destination communicating entity's estimate of the propagation channel. The destination communicating entity bases this estimate on its knowledge of pilots previously transmitted by the source communicating entity. The estimate of the propagation channel is then delivered to the source communicating entity.

Thus inserting pilots makes it possible to estimate the propagation channel, but this requires the use of complex techniques in the destination communicating entity. Furthermore, the complexity of the channel estimator increases with the number of pilots available, and the requirement in terms of radio resources necessary to deliver the estimate increases with the accuracy of the estimate required to guarantee effective pre-equalization. A compromise must therefore be achieved between the accuracy of the estimate of the propagation channel and the consumption of radio resources used to transmit the pilots and the estimate of the channel.

An alternative method is described in the paper entitled “Blind beamforming in frequency division duplex MISO systems based on time-reversal mirrors” by Tobias Dahl and Jan Egil Kirkebo, presented at the IEEE Conference 6th Workshop on Signal Processing Advances in Wireless Communications, June 2005, SPAWC.2055.1506218, pages 640-644. That so-called blind method is based on a round trip of the antenna signal between the communicating entities. The time-reversal coefficients applied at a given time are obtained from the stored data signal and the pre-equalization coefficients applied to that signal at a previous time. That method therefore makes it possible to dispense with the use of pilots and channel estimation, but at the cost of increased complexity and voluminous digital signal storage.

Neither of the solutions described above, respectively based on using pilots and on using an antenna signal round trip, is entirely satisfactory. The invention therefore proposes an alternative solution offering a pre-equalization method based on time reversal with reduced complexity and without using pilots. This solution is furthermore suitable for communicating entities with a single antenna for which the data signal consists of a single antenna signal and for communicating entities with a plurality of antennas for which the data signal consists of a plurality of antenna signals.

To achieve this object, the invention provides a method of pre-equalizing a frequency-division duplex data signal transmitted by a source communicating entity including a set of source antennas to a destination communicating entity including a set of destination antennas. The method includes:
a step of a reference antenna of the set of source antennas receiving a first pulse transmitted by a destination antenna via a first propagation channel;
a step of a source antenna transmitting a second pulse via a second propagation channel between said source antenna and the destination antenna;
a step of the reference antenna receiving a combined impulse response representing the successive passages of the second pulse through the second propagation channel and the first propagation channel;
a step of time reversing the combined impulse response;
a step of combining the time-reversed combined impulse response and an impulse response representing the passage of the first pulse through the first propagation channel,
   said steps being repeated for at least a portion of the set of destination antennas and at least a portion of the set of source antennas;
a step of determining pre-equalization coefficients of the data signal from a set of said combinations of impulse responses.

This method thus makes it possible to dispense with transmission of pilots by the source communicating entity. Moreover, the destination communicating entity releases the resources previously intended for supplying the propagation channel estimate or estimates. The method further makes it possible to adapt to different precoding and modulation methods applied to binary data to generate a data signal including a plurality of antenna signals.

The complexity of the method of the invention used in the source communicating entity to pre-equalize a data signal is thus limited to the transmission and reception of pulses and to time reversal of a combination of pulses.

It should be noted that the solution of the invention is particularly advantageous compared to the method described in the document US 2007/0099571 of forming transmit antenna beams adapted to the propagation channels. According to that document, to preserve the integrity of the transmitted signal, the antenna beams are determined by applying pre-equalization coefficients to the signal with the aim of canceling the effect of the propagation channel through which the signal is to pass. In contrast to the invention, the consequence here of canceling the effect of the propagation channel is that the energy of the signal is not concentrated at the focal point. According to the invention, the pre-equalization coefficients are determined to concentrate the energy of the signal at the focal point by applying time reversal and thereby reducing the spreading of the propagation channel through which the signal is to pass.

The document EP 0936781 describes an alternative way of determining pre-equalization coefficients, also based on a pulse round trip, aiming to cancel out the effect of the propagation channel using complex matrix inversion. The coefficients obtained likewise do not make it possible to concentrate the energy at the focal point.

The calculations of these two prior art methods are furthermore of much greater complexity than the present invention.

The method further includes in the step of receiving the first pulse transmitted by the destination antenna selecting the reference antenna as a function of a set of pulses received via the set of source antennas. This selection is effected as a function of the energy of the pulses of the set of pulses received by the set of source antennas, for example.

This selection thus makes it possible to give preference to the second propagation channel in which the energy of the signal is the least attenuated, for example.

The method further includes a step of the destination antenna receiving the second pulse transmitted by the source antenna and a step of the destination antenna transmitting the received second pulse to the source communicating entity.

The complexity of the method of the invention used in the destination communicating entity to pre-equalize a data signal transmitted by the source communicating entity is thus limited to receiving a pulse transmitted by the source entity and transmitting it back to the source communicating entity.

The invention also provides a device for pre-equalizing a transmitted frequency-division duplex data signal for a source communicating entity including a set of source antennas, the source communicating entity being adapted to transmit the signal to a destination communicating entity including a set of destination antennas. The device includes:
means for enabling a reference antenna of the set of source antennas to receive a first pulse transmitted by a destination antenna via a first propagation channel;
means for enabling a source antenna to transmit a second pulse;
means for enabling the reference antenna to receive a combined impulse response representing the successive passages of the second pulse through a second propagation channel between the source antenna and the destination antenna and the first propagation channel;
means for time reversing the combined impulse response;
means for combining the time-reversed combined impulse response and an impulse response representing the passage of the first pulse through the first propagation channel; and
means for determining pre-equalization coefficients of the data signal from a set of combinations of impulse responses;

the receiving, time reversing, and combining means being employed iteratively for at least a portion of the set of destination antennas and at least a portion of the set of source antennas.

The invention further provides a device for pre-equalizing a frequency-division duplex data signal for a destination communicating entity including a set of destination antennas, the destination communicating entity being able to receive the data signal transmitted by a source communicating entity including a device as described above, the source communicating entity including a set of source antennas. The device includes:
means for enabling transmission of a first pulse by a destination antenna to the source communicating entity;
means for receiving a second pulse transmitted by a source antenna; and
means for transmitting the second pulse received by the destination antenna;

the transmission and reception means being employed iteratively for at least a portion of the set of destination antennas and at least a portion of the set of source antennas.

The invention further provides a communicating entity of a radio communications system including at least one of the above devices for pre-equalizing a data signal.

The invention further provides a radio communications system including at least two communicating entities of the invention.

The above devices, communicating entities and system have advantages similar to those described above.

Other features and advantages of the present invention become more clearly apparent on reading the following description of the method of particular embodiments of the invention for pre-equalizing a data signal and associated communicating entities, given by way of illustrative and non-limiting example only and with reference to the appended drawings, in which:

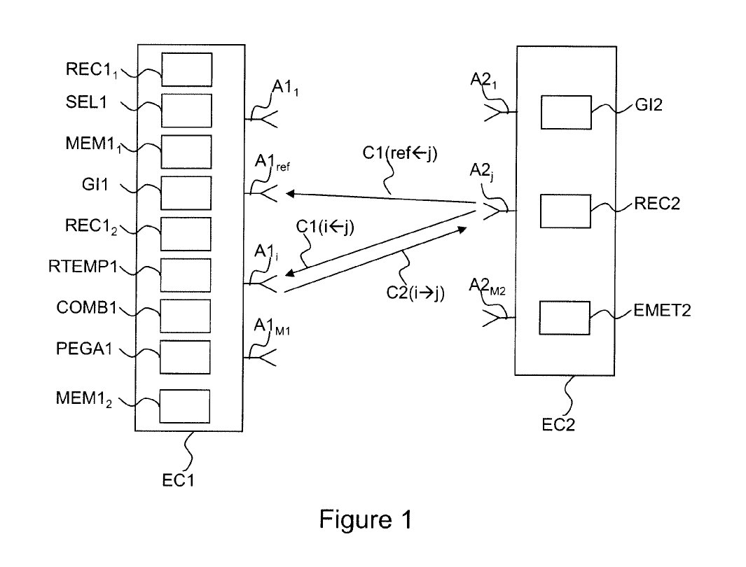

FIG. 1 is a block diagram of a source communicating entity of the invention communicating with a destination communicating entity of the invention;

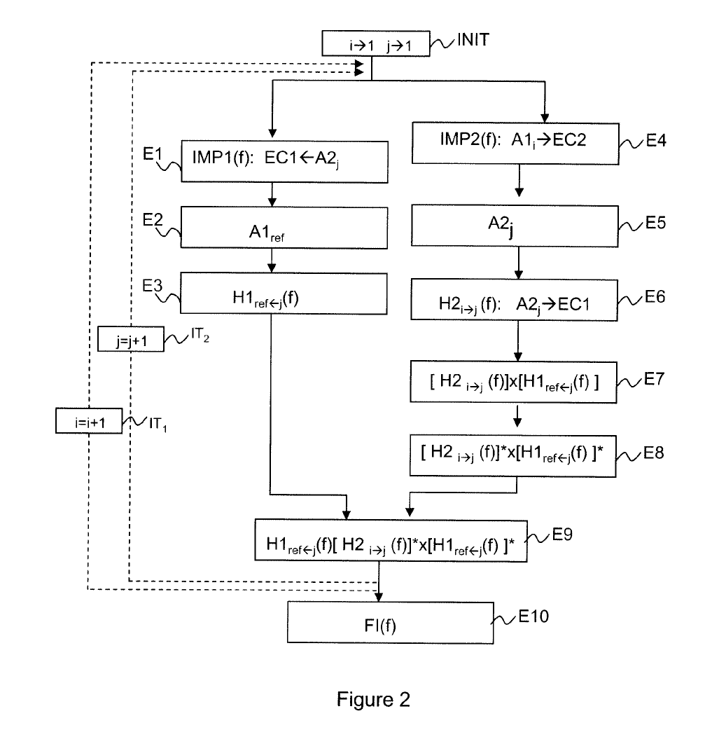

FIG. 2 represents the steps of the method of a first particular implementation of the invention of pre-equalizing a data signal; and

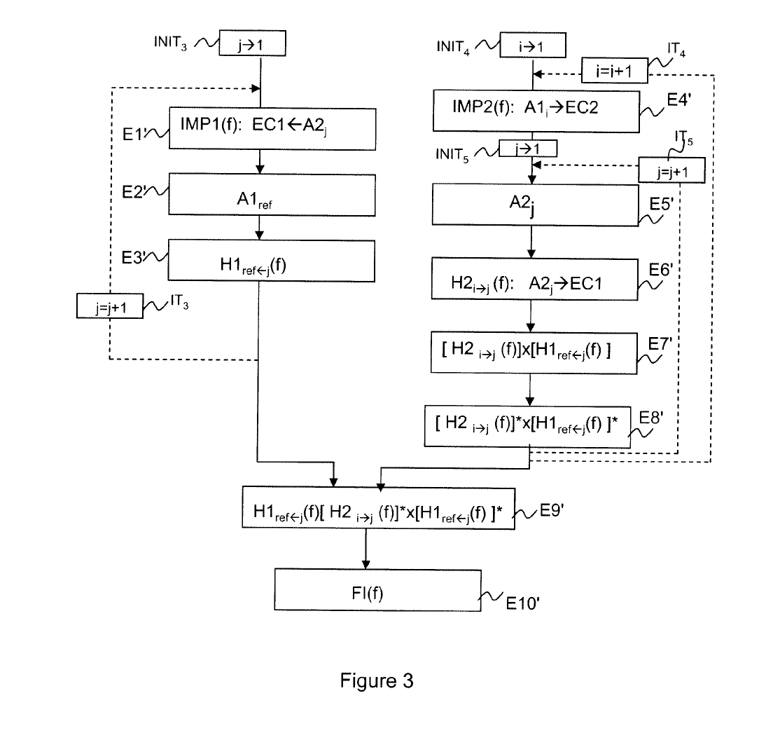

FIG. 3 represents the steps of the method of a second particular implementation of the invention of pre-equalizing a data signal.

Referring to FIG. 1, a source communicating entity EC1 is able to communicate with a destination communicating entity EC2 via a frequency division duplex (FDD) radio communications network not represented in the figure.

For example, the radio communications network is a UMTS (Universal Mobile Communications system) cellular radio communications network defined by the 3GPP (3rd Generation Partnership Project) organization and evolutions thereof including 3GPP-LTE (Long Term Evolution).

Possible communicating entities are mobile terminals, terrestrial and satellite base stations, and access points. FDD uplink transmission from a base station to a mobile radio terminal is effected in a frequency band different from the frequency band dedicated to downlink transmission from a mobile radio terminal to a base station. For clarity, the invention is described for the unidirectional transmission of a data signal from the communicating entity EC1 to the communicating entity EC2, whether that is in the uplink direction or in the downlink direction. The invention also relates to bidirectional transmission.

The source communicating entity EC1 has M1 source antennas (A1₁, . . . A1_{ref}, . . . A1ᵢ, . . . A1_{M1}), where M1 is greater than or equal to 1. The destination communicating entity has M2 destination antennas (A2₁, . . . A2ⱼ, . . . A2_{M2}) where M2 is greater than or equal to 1.

The destination communicating entity EC2 is able to transmit a pulse or a radio signal from any one or more of the antennas A2ⱼ, for j between 1 and M2 inclusive, in a first frequency band. A first propagation channel C1(A1ᵢ←A2ⱼ) is defined between the antenna A2ⱼ of the communicating entity EC2 and an antenna A1ᵢ of the source communicating entity EC1. Thus M1×M2 first propagation channels C1(A1ᵢ←A2ⱼ), for i varying from 1 to M1 and j varying from 1 to M2, are defined between the communicating entities EC1 and EC2.

The source communicating entity EC1 is adapted to transmit a radio signal or pulse from any one or more of the antennas A1ᵢ, for i between 1 and M1 inclusive, to the destination communication entity EC2 in a second frequency band different from the first. A second propagation channel C2(A1ᵢ→A2ⱼ) is defined between the antenna A1ᵢ of the communicating entity EC1 and an antenna A2ⱼ of the destination communicating entity EC2 for transmission from the communicating entity EC1 to the communicating entity EC2. Thus M1×M2 second propagation channels C2(A1ᵢ→A2ⱼ), for i varying from 1 to M1 and j varying from 1 to M2, are defined between the communicating entities EC1 and EC2.

FIG. 1 shows only those means of the source and destination communicating entities that relate to the invention.

The source and destination communicating entities further include a central control unit, not shown, connected to the means that they include to control the operation thereof.

The source communicating entity further includes a generator of data signals including M1 antenna signals. Such antenna signals are defined by binary data through methods of modulation, coding and distribution to the M1 antennas, for example as described in the paper “Space Block Coding: a simple transmitter diversity technique for wireless communications” by S. Alamouti, published in IEEE Journal Selected Areas In Communications, vol. 16, pp. 1456-1458, October 1998.

The source communicating entity includes:
a receiver REC1₁ adapted to receive via all the source antennas a pulse transmitted by the communicating entity EC2;
an antenna selector SEL1 adapted to select a reference antenna on the basis of all the impulse responses received by the receiver REC1 via the source antennas;
a memory MEM1₁ storing a transfer function or an impulse response received by the receiver REC1 via the reference antenna determined by the antenna selector SEL1;
a pulse generator GI1 adapted to transmit a pulse from any antenna A1ᵢ, for i between 1 and M1 inclusive, on a carrier frequency f1 from the frequency band dedicated to transmission from the communicating entity EC1 to the communicating entity EC2;
a receiver REC1₂ adapted to receive a combined impulse response via a reference antenna selected by the antenna selector SEL1;
a pulse analyzer RTEMP1 adapted to time reverse a combined impulse response delivered by the receiver REC1₂;
a computer COMB1 adapted to combine an impulse response stored in the memory MEM1₁ and a time-reversed combined impulse response delivered by the pulse analyzer RTEMP1;
a memory MEM1₂ storing impulse responses or transfer functions determined iteratively by the computer COMB1;
a pre-equalizer PEGA1 adapted to determine pre-equalization coefficients from a combination of transfer functions or impulse responses stored in the memory MEM1₂.

Of course, the memories MEM1₁ and MEM1₂ can be provided by a single storage module. Similarly, the receivers REC1₁ and REC1₂ can be provided by a single radio signal receiver module.

The destination communicating entity includes:
a pulse generator GI2 adapted to transmit a pulse from any destination antenna A2ⱼ, for j between 1 and M2 inclusive, on a carrier frequency f2 from the frequency band dedicated to transmission from the communicating entity EC2 to the communicating entity EC1;
a receiver REC2 adapted to receive via a destination antenna a pulse transmitted by the source communicating entity;
a transmitter EMET2 adapted to transmit via a destination antenna an impulse response delivered by the receiver REC2.

The various means of the source and destination communicating entities can be implemented in analog or digital technologies well known to persons skilled in the art.

The method of the invention shown in FIG. 2 for pre-equalizing a data signal comprises steps E1 to E10. In this example the outcomes of these steps are described in the frequency domain but can be transposed directly to the time domain given the following definitions.

A time pulse is defined by a function imp(t) as a function of time t, of transfer function that is given by IMP(f), which is a function of frequency f. Similarly, an impulse response is defined by a function ri(t) as a function of time t, of transfer function that is given by RI(f), which is a function of frequency f. The convolution product of the impulse responses corresponds to the product of the corresponding transfer functions. A time-reversed impulse response ri(t) is denoted ri(−t) and the corresponding transfer function is RI(f)*, which is conjugate with the transfer function RI(f).

The steps E1 to E9 are repeated for at least some of the destination antennas and at least some of the source antennas. The iterations are symbolized by an initialization step INIT and a step IT₁ of incrementing the index i of the source antennas A1ᵢ and a step IT₂ of iterating the index j of the destination antennas A2ⱼ. One iteration of the steps E1 to E9 is described for a source antenna A1ᵢ and a destination antenna A2ⱼ.

In the step E1, the pulse generator GI2 of the destination communicating entity generates the time pulse imp1(t) of transfer function that is IMP1(f). This pulse is transmitted via the antenna A2ⱼ on a carrier frequency f2 in the frequency band dedicated to transmission from the communicating entity EC2 to the communicating entity EC1.

For example, the pulse is a raised cosine function with a duration inversely proportional to the size of the frequency band in which the system functions for any type of access, for example orthogonal frequency division modulation access (OFDMA), code division multiple access (CDMA) or time division multiple access (TDMA).

In the next step E2, the receiver REC1₁ of the source communicating entity receives the pulse transmitted by the communicating entity EC2 via all the source antennas. The antenna selector SEL1 determines a reference antenna on the basis of all the pulses received by the receiver REC1₁ via all the source antennas, for example by comparing the energies received via the various source antennas, and selects the impulse response with the maximum energy. Alternatively, the antenna selector selects the antenna at which the pulse is the least spread out in time. Alternatively, the antenna selector selects a reference antenna at random.

In the next step E3 the receiver REC1₁ delivers the pulse received via the reference antenna to the memory MEM1₁ of the source communicating entity. The transfer function of the pulse imp1(t) that has passed through a first propagation channel C1(ref←j) between the destination antenna A2ⱼ and the reference antenna A1_{ref} is denoted H1_{ref←j}(f).

In parallel with the step E1, the pulse generator GI1 of the source communicating entity generates a pulse imp2(t) of transfer function that is IMP2(f). This pulse is transmitted via the source antenna A1ᵢ on a carrier frequency f1 in the frequency band dedicated to transmission from the communicating entity EC1 to the communicating entity EC2.

In the step E5 following the step E4, the receiver REC2 of the destination communicating entity receives the pulse imp2(t) via all the destination antennas. The receiver REC2 delivers the impulse response received via the destination antenna A2ⱼ to the transmitter EMET2 of the destination communicating entity. This impulse response represents the pulse imp2(t) passing through a second propagation channel C2(i→j) between the source antenna A1ᵢ and the destination antenna A2ⱼ.

In the next step E6, the transmitter EMET2 transposes the impulse response received by the receiver REC2 from the carrier frequency f1 to the carrier frequency f2. The antenna A2ⱼ then transmits the transposed impulse response to the source communicating entity.

In the step E7, the receiver REC1₂ of the source communicating entity EC1 receives an impulse response or combined impulse response ri_{comb}(t) via all the source antennas. The receiver REC1₂ selects the combined impulse response received via the reference antenna A1_{ref} corresponding to a round trip between the communicating entities of the pulse imp2(t) transmitted during the step E4. The transfer function representing this successive passage through the first and second propagation channels is given by the equation:

RI_{comb}(f)=H2_{i→j}(f)×H1_{ref←j}(f)

where H1_{ref←j}(f) is the transfer function of the first propagation channel C1(A1_{ref}←A2ⱼ) and H2_{i←j}(f) is the transfer function of the second propagation channel C2(A1_{ref}←A2ⱼ). The receiver REC1₂ delivers the combined impulse response to the pulse analyzer RTEMP1 of the source communicating entity.

In the step E8, the pulse analyzer RTEMP1 time reverses the combined impulse response. To this end, the pulse analyzer stores the combined impulse response, for example by storing the coefficients of the combined impulse response, and classifies the conjugates thereof in the reverse order to the coefficients of ri_{comb}(t). The transfer function of the time-reversed combined impulse response ri_{comb}(−t) is therefore given by the equation:

Ri_{comb}(f)*=[H2_{i→j}(f)]*×[H1_{ref←j}(f)]*

Alternatively, the pulse analyzer analyzes the impulse response ri_{comb}(t) using an analog splitter and deduces a discrete model of the combined impulse response. The analyzer then applies the time reversal on the basis of the discrete model.

In the next step E9, the computer COMB1 combines the impulse response ri_{comb}(−t) and the impulse response stored during the step E3 in the memory MEM1₁ of the source communicating entity. The combination is effected by the product of convolution of the above-mentioned impulse responses or the product of the corresponding transfer functions. The transfer function Hᵢⱼ(f) of the resulting impulse response rᵢⱼ(t) is given by the equation:

Hᵢⱼ(f)=H1_{ref←j}(f)×[H2_{i→j}(f)]*×[H1_{ref←j}(f)]*

The impulse response rᵢⱼ(t) is then stored in the memory MEM1₂ of the source communicating entity.

The succession of steps E1 to E3 and the succession of steps E4 to E8 can be executed in parallel. Thus the method requires only simple cooperation between the communicating entities. However, the step E9 is not activated until after execution of the steps E2 and E3 following on from the transmission of a pulse by the communicating entity EC2 and execution of the steps E5 to E8 following on from the transmission of a pulse by the destination communicating entity EC1. Synchronization of the communicating entities then makes it possible to optimize activation of the step E9, for example by executing the steps E1 and E4 simultaneously.

The steps E1 to E9 being repeated for some of the source antennas and some of the destination antennas, the memory MEM1₂ of the source communicating entity includes a stored set of transfer functions or impulse responses. For the iterations effected on M1 destination antennas and M2 source antennas, the memory MEM1₂ contains M1×M2 transfer functions Hᵢⱼ(f), for i varying from 1 to M1 and j varying from 1 to M2.

In step E10, the pre-equalizer PEGA1 of the source communicating entity determines pre-equalization coefficients of a data signal S(t) including M1 antenna signals S₁(t), . . . , Sᵢ(t), . . . , S_{M1}(t) by combining transfer functions Hᵢⱼ(f) to form a set FI of M1 pre-equalization filters FIᵢ(f), i varying from 1 to M1. The antenna signal Sᵢ(t) transmitted via the antenna A1ᵢ is therefore shaped by applying the corresponding filter FIᵢ(f) defined by the following equation:

$${FI}_{i} ( f ) = {\sum }_{j = 1}^{M 2} {C}_{j} {H}_{ij} ( f )$$

The weighting coefficients Cⱼ, for j between 1 and M2 inclusive, are configurable parameters determined as a function of the method used to generate a data signal. These parameters are also updated, for example when turning a destination antenna off or on, as a function of the evolution over time of the states of the propagation channels.

After the step E10, the data signal is pre-equalized by filtering each of the antenna signals by the corresponding filter of the set FI and sent by the communicating entity EC1 to the communicating entity EC2.

In one particular implementation, steps E1 to E9 are executed for only one source antenna A1ᵢ from the set of source antennas. This implementation corresponds to the situation in which the data signal to be equalized is the antenna signal Sᵢ(t). The memory MEM1₂ of the source communicating entity contains M2 transfer functions Hᵢⱼ(f) for j varying from 1 to M2. The pre-equalizer PEGA1 determines a single pre-equalization filter FIᵢ(f). The antenna signal Sᵢ(t) transmitted via the antenna A1ᵢ is therefore shaped by applying the corresponding filter FIᵢ(f) given by the equation:

$${FI}_{i} ( f ) = {\sum }_{j = 1}^{M 2} {C}_{j} {H}_{ij} ( f )$$

In one particular embodiment, the set of destination antennas contains only one destination antenna A2₁. The steps E1 to E9 are executed only to transmit a single first pulse via the antenna A2₁ of the destination communicating entity.

By way of illustrative example, when the steps E1 to E9 are repeated for all the source antennas, the pre-equalizer determines pre-equalization coefficients in step E10 as a function of M1 transfer functions Hᵢ₁(f), i varying from 1 to M1. The set FI of M1 pre-equalization filters FIᵢ(f) to be applied to the data signal is given by the equation:

FI=[FI₁, . . . , FIᵢ(f), . . . , FI_{M1}(f)] where

FIᵢ(f)=Hᵢ₁(f)

In one particular embodiment, the set of source antennas contains only one source antenna A1₁. The data signal then includes only one antenna signal S₁(t) transmitted by the one source antenna and the reference antenna is the source antenna A1₁. Steps E1 to E9 are executed only to transmit a single second pulse via the single antenna A1₁ of the source communicating entity.

By way of illustrative example, when steps E1 to E9 are repeated for all the destination antennas, M2 transfer functions H₁ⱼ, for j varying from 1 to M2, are available in the step E10. The pre-equalizer determines a single pre-equalization filter FI₁(f) applied to the data signal on the basis of M2 coefficients Cⱼ such that:

$${FI}_{1} ( f ) = {\sum }_{j = 1}^{M 2} {C}_{j} {H}_{1 j} ( f )$$

In one particular embodiment, the set of source antennas contains only one source antenna A1₁ and the set of destination antennas contains only one destination antenna A2₁. The data signal includes only one antenna signal S₁(t) and the reference antenna of the source antenna is the antenna A1₁. Steps E1 to E9 are executed only to transmit a single first pulse via the destination antenna A2₁ and to transmit a single second pulse via the source antenna A1₁. In step E10, the transfer function H₁₁(f) determines a single pre-equalization filter FI1 given by the equation:

FI₁(f)=H₁₁(f)

FIG. 3 represents the steps of the method of a second particular implementation of the invention of pre-equalizing a data signal. The method includes steps E1′ to E10′ similar to steps E1 to E10 described above, for which the source antenna and destination antenna iteration loops are modified.

Steps E1′ to E3′ are repeated for at least some of the destination antennas. The iterations are symbolized by an initialization step INIT₃ and step IT₃ of incrementing the index j of the destination antennas A1ᵢ.

Thus iteration of steps E1′ to E3′ corresponding to a destination antenna A2ⱼ comprises:
during step E1′, transmitting via the destination antenna A2ⱼ a time pulse imp1(t);
during step E2′, receiving the pulse transmitted by the receiver REC1₁ and selecting the reference antenna;
during E3′, storing the impulse response received via the reference antenna in the memory MEM1₁; denoted H1_{ref←j}(f) denotes the transfer function corresponding to the pulse imp1(t) that has passed through a first propagation channel C1(ref←j) between the destination antenna A2ⱼ and the reference antenna A1_{ref}.

Steps E1′ to E3′ being repeated for at least some of the set of destination antennas, the memory MEM1₁ of the source communicating entity then contains all the transfer functions obtained successively during the iterations.

In parallel with the iterations of steps E1′ to E3′, the pulse generator GI1 of the source communicating entity generates a pulse imp2(t) in the step E4′ of corresponding transfer function that is IMP2(f). This pulse is transmitted iteratively via each antenna of a portion of the set of source antennas. The iterations are symbolized by an initialization step INIT₄ and a step IT₄ of incrementing the index i of the source antennas A1ᵢ.

For an iteration corresponding to transmitting the pulse imp2(t) via the source antenna A1ᵢ, steps E5′ to E8′ are repeated for some of the destination antennas.

The iteration of the steps E5′ to E8′ is symbolized by an initialization step INIT₅ and a step IT₅ of incrementing the index j of the destination antennas A2ⱼ.

Thus iteration of steps E5′ to E8′ for a destination antenna A2ⱼ comprises:
during step E5′, the receiver REC2 of the destination communicating entity receiving the pulse transmitted via the source antenna A1ᵢ;
during step E6′, the transmitter EMET2 transmitting via the destination antenna A2ⱼ the impulse response received via the destination antenna A2ⱼ;
during step E7′, the receiver REC1₂ receiving the combined impulse response ri_{comb}(t); the receiver REC1₂ selects the combined impulse response received via the reference antenna A1_{ref} corresponding to a round trip of the pulse imp2(t) transmitted during an iteration of step E4′ and the transfer function of which, representing successive passage through the first and second propagation channels, is given by the equation:

RI_{comb}(f)=H2_{i→j}(f)×H1_{ref←j}(f)
during step E8′, the pulse analyzer RTEMP1 time reversing the combined impulse response ri_{comb}(t).

The time-reversed combined impulse response is then stored in the memory MEM1₂ of the corresponding source communicating entity for iteration of steps E5′ to E8′ for the destination antenna A2ⱼ.

Steps E5′ to E8′ being repeated for at least a portion of the set of source antennas, the memory MEM1₂ contains for the destination antenna A2ⱼ all the combined impulse responses obtained successively during iteration of the index i.

After iteration of a portion of the set of destination antennas, the memory MEM1₂ of the source communicating entity then contains the set of transfer functions H2(_{i→j}(f))*×[H1_{ref←j}(f)]*.

The succession of steps E1′ to E3′ and the succession of steps E4′ to E8′ can be executed in parallel. However, a first iteration of the step E7′ for an antenna A1ᵢ can be effected only after a reference antenna is selected during the first iteration of step E2′. Thus this implementation makes it possible to optimize the number of exchanges between the communicating entities although it adds constraints associated with synchronizing the steps between the two communicating entities.

During step E9′, the computer COMB1 of the source communicating entity combines the impulse responses stored in the memory MEM1₁ and the time-reversed combined impulse responses stored in the memory MEM1₂.

For a source antenna with index i, for i between 1 and M1 inclusive, and a destination antenna with index j, for j between 1 and M2 inclusive, the computer COMB1 thus determines the transfer function Hᵢⱼ(f) given by the equation:

Hᵢⱼ(f)=H1_{ref←j}(f)×[H2_{i→j}(f)]*×[H1_{ref←j}(f)]*

For iterations effected on all the source antennas and all the destination antennas, the computer COMB1 of the source communicating entity effects M1×M2 combinations of the impulse responses stored in the memory MEM1₁ and the time-reversed combined impulse responses stored in the memory MEM1₂.

In the step E10′, the pre-equalizer PEGA1 of the source communicating entity determines pre-equalization coefficients for a data signal S(t) that includes M1 antenna signals [S₁(t), . . . , Sᵢ(t), . . . , S_{M1}(t)] on the basis of a combination of transfer functions Hᵢⱼ(f) to form a set FI of M1 pre-equalization filters FIᵢ(f), for i varying from 1 to M1, for iteration loops effected for all the destination antennas. The antenna signal Sᵢ(t) transmitted via the antenna A1ᵢ is therefore shaped by applying the corresponding filter FIᵢ(f) given by the equation:

$${FI}_{i} ( f ) = {\sum }_{j = 1}^{M 2} {C}_{j} {H}_{ij} ( f )$$

The data signal is thus pre-equalized by filtering each of the antenna signals by the corresponding filter of the set FI and transmitted by the communicating entity EC1 to the communicating entity EC2.

In one particular implementation, step E1′ and the iterative loop over steps E5′ to E8′ are effected for only a single source antenna A1ᵢ from the set of source antennas. This implementation corresponds to the situation in which the data signal to be equalized is the antenna signal Sᵢ(t). The memory MEM1₂ of the source communicating entity contains M2 transfer functions Hᵢⱼ(f) for j varying from 1 to M2. The pre-equalizer PEGA1 determines a single pre-equalization filter FIᵢ(f). The antenna signal Sᵢ(t) transmitted via the antenna A1ᵢ is thus shaped by applying the corresponding filter FIᵢ(f) given by the equation:

$${FI}_{i} ( f ) = {\sum }_{j = 1}^{M 2} {C}_{j} {H}_{ij} ( f )$$

The method can also be used for bidirectional transmission. In this particular implementation, the method is used in the uplink direction and the downlink direction in the first or second implementation corresponding to FIG. 2 or 3 so that a pulse and an antenna signal are not transmitted simultaneously by a communicating entity. This is in order to ensure the processing of impulse responses representing passing through one or more propagation channels.

In the implementations described corresponding to FIG. 2 or FIG. 3, the iteration loops are executed for some destination antennas and some source antennas. The number of antennas and the chosen antennas are configurable parameters of the method. They are determined as a function of the characteristics of the antennas, for example.

The invention described here provides a device used in a source communicating entity to pre-equalize a data signal. Consequently, the invention also provides a computer program, notably a computer program on or in an information storage medium, adapted to implement the invention. This program can use any programming language and take the form of source code, object code or a code intermediate between source code and object code, such as a partially-compiled form, or any other form suitable for implementing those of the steps of the method of the invention executed in the source communication entity.

The invention described here also provides a device used in a destination communicating entity to pre-equalize a data signal. Consequently, the invention also provides a computer program, notably a computer program on or in an information storage medium, adapted to implement the invention. This program can use any programming language and take the form of source code, object code or a code intermediate between source code and object code, such as a partially-compiled form, or any other form suitable for implementing those of the steps of the method of the invention executed in the destination communication entity.

1. A method of pre-equalizing a frequency-division duplex data signal transmitted by a source communication entity comprising a set of source antennas to a destination communicating entity comprising a set of destination antennas, said method comprising steps of:
a reference antenna of the set of source antennas receiving a first pulse transmitted by a destination antenna via a first propagation channel;
a source antenna transmitting a second pulse via a second propagation channel between said source antenna and the destination antenna;
the reference antenna receiving a combined impulse response representing the successive passages of said second pulse through said second propagation channel and said first propagation channel;
time reversing the combined impulse response;
combining the time-reversed combined impulse response and an impulse response representing the passage of said first pulse through said first propagation channel, said steps being repeated for at least a portion of the set of destination antennas and at least a portion of the set of source antennas;
determining pre-equalization coefficients of the data signal from a set of said combinations of impulse responses.

2. The method according to claim 1, wherein the step of receiving the first pulse transmitted by the destination antenna includes beforehand selecting the reference antenna as a function of a set of pulses received by the set of source antennas.

3. The method according to claim 2, wherein the reference antenna is selected as a function of the energy of the pulses of the set of pulses received by the set of source antennas.

4. The method according to claim 1, further comprising steps of:
the destination antenna receiving the second pulse transmitted by the source antenna;
the destination antenna transmitting the received second pulse to the source communicating entity.

5. A device for pre-equalizing a transmitted frequency-division duplex data signal for a source communication entity comprising a set of source antennas adapted to transmit said signal to a destination communicating entity comprising a set of destination antennas, said device comprising means for:
enabling a reference antenna of the set of source antennas to receive a first pulse transmitted by a destination antenna via a first propagation channel;
enabling a source antenna to transmit a second pulse via a second propagation channel between said source antenna and the destination antenna;
enabling the reference antenna to receive a combined impulse response representing the successive passages of said second pulse through said second propagation channel and said first propagation channel;
time reversing the combined impulse response;
combining the time-reversed combined impulse response and an impulse response representing the passage of said first pulse through said first propagation channel;
determining pre-equalization coefficients of the data signal from a set of combinations of impulse responses;
the receiving, time reversing and combining means being employed iteratively for at least a portion of the set of destination antennas and at least a portion of the set of source antennas.

6. A device for pre-equalizing a frequency-division duplex data signal for a destination communicating entity comprising a set of destination antennas, said destination communicating entity being able to receive said data signal transmitted by a source communicating entity comprising a device according to claim 5, said source communicating entity comprising a set of source antennas, said device comprising means for:
enabling transmission of a first pulse by a destination antenna to the source communicating entity;
receiving a second pulse transmitted by a source antenna;
transmitting said second pulse received by the destination antenna;
the transmission and reception means being employed iteratively for at least a portion of the set of destination antennas and at least a portion of the set of source antennas.

7. A communicating entity of a radio communications system, comprising at least one device according to claim 5.

8. A radio communications system comprising at least two communicating entities according to claim 7.

9. A computer program for a source communicating entity, comprising software instructions for controlling the execution by said entity of those of the steps of the method according to claim 1 that are executed by the source communicating entity when the program is executed by the source communicating entity.

10. A computer program for a destination communicating entity, comprising software instructions for controlling the execution by said entity of those of the steps of the method according to claim 4 that are executed by the destination communicating entity when the program is executed by the destination communicating entity.
